(19) United States
(12) Patent Application Publication
(10) Pub. No.: US 2013/0262908 A1
(43) Pub. Date: Oct. 3, 2013

(54) PROCESSING DEVICE AND METHOD FOR CONTROLLING PROCESSING DEVICE

(71) Applicant: FUJITSU LIMITED, Kawasaki-shi (JP)

(72) Inventor: Norihito GOMYO, Tama (JP)

(73) Assignee: FUJITSU LIMITED, Kawasaki-shi (JP)

(21) Appl. No.: 13/756,586

(22) Filed: Feb. 1, 2013

(30) Foreign Application Priority Data
Mar. 27, 2012 (JP) 2012-071381

(51) Int. Cl. G06F 1/08

(52) U.S. Cl. CPC G06F 1/08
USPC 713/501

(57) ABSTRACT

A processing device includes: a clock generating circuit that outputs a clock; an instruction executing circuit that is capable of a state change between an instruction executing state where an instruction is executed and an instruction stop state where an instruction is stopped; a first circuit that inhibits the supply of the clock to an internal circuit when a first clock inhibition signal is input; a second circuit that inhibits the supply of the clock to an internal circuit when a second clock inhibition signal is input; and a control circuit, and the control circuit outputs the second clock inhibition signal to the second circuit after outputting the first clock inhibition signal to the first circuit, when the instruction executing circuit changes from the instruction executing state to the instruction stop state.

### CROSS-REFERENCE TO RELATED APPLICATION

This application is based upon and claims the benefit of priority of the prior Japanese Patent Application No. 2012-071381, filed on Mar. 27, 2012, the entire contents of which are incorporated herein by reference.

### FIELD

The embodiment discussed herein is directed to a processing device and a method for controlling the processing device.

### BACKGROUND

In a field of a processing device such as a processor, there has been conventionally a problem that a power supply potential changes due to a sharp and great change in power consumed by circuits in the processing device, causing the occurrence of power supply noise. Since such a power supply noise will be a cause of a malfunction of the circuits, there have been proposed techniques for preventing the occurrence of the power supply noise.

For example, there has been proposed a flip-flop control circuit including a circuit which generates a first clock pulse with a fundamental frequency and a circuit which generates a second clock pulse with a frequency higher than the fundamental frequency (refer to Patent Document 1). The first clock pulse is output to flip-flops after a start signal deciding states of the flip-flops is generated, and after the predetermined time passes, the second clock pulse is output to the flip-flops. By such a configuration, the clock pulses supplied to the flip-flops are reduced than conventionally, thereby realizing a reduction in the power supply noise.

Further, for example, in a LSI (Large Scale Integrated circuit) realizing a low power consumption mode by ON/OFF controlling of clocks, there has been proposed a clock control circuit including a circuit which thins out the clocks in response to a power management signal (refer to Patent Document 2). At the time of a change from the low power consumption mode to a regular operation mode or vice versa, the clocks are supplied to circuit blocks while the frequency is changed in stages in a predetermined time, thereby preventing a sharp change in power supply current ascribable to ON/OFF controlling of the clocks.

Further, there has been proposed, for example, a technique reducing a change in power consumption in a semiconductor integrated circuit device including a plurality of circuit blocks and a power control circuit (refer to Patent Document 3). A storage unit is provided which stores a permissible value (upper limit) of power consumption that the power control circuit refers to when deciding operating states (operating or stopping) of the circuit blocks. The operations of the circuit blocks are decided so that the permissible value of the power consumption is not exceeded, and the permissible value is changed in stages, whereby the number of the operable circuit blocks is decreased to reduce a change in the power consumption.

In order to have improved performance, a recent processor includes a plurality of arithmetic units in its core to execute a plurality of instructions in parallel, and further a plurality of cores are mounted in the processor, making it possible to increase the number of instructions executable in parallel per cycle of a clock. Increasing the number of the arithmetic units and the number of the cores included in the processor results in an increase in the power consumption of the whole processor. Generally, in such a processor, for each of the circuits in the processor such as a register file, RAM (Random Access Memory), and the arithmetic units, a clock gating circuit capable of inhibiting the application of a clock to the circuit is provided, whereby power saving control is performed more delicately. In this power saving control, the clock is supplied to the circuit only when an access (a read access or a write access) to the circuit is required, and otherwise, the supply of the clock is stopped. Since access timing of each of the circuits differs depending on each of the circuits, the circuits each independently control a clock stop condition, thereby realizing a reduction in power.

Further, a recent processor includes a suspend instruction or a sleep instruction that temporarily stops instruction processing by its core for the purpose of power saving. The suspend instruction stops the instruction processing over a relatively long period until a factor such as a timer interrupt or an external interrupt occurs. Further, the sleep instruction stops the instruction processing only for a relatively short period such as a synchronization standby with the other cores. While the instruction processing is stopped by the suspend instruction or the sleep instruction, since the arithmetic units are in halt, combination circuits in the arithmetic units consume no power, so that power consumption decreases. Further, while the instruction processing is stopped, since the RAM or the register file is not accessed, the supply of the clock to the RAM and the register file is stopped by the clock gating, so that power consumption decreases.

In accordance with the increase in the number of the cores and the improvement in the power saving technique, a difference between power consumption while the processor is executing the arithmetic operation and power consumption while the instruction processing is stopped is becoming large. That is, a change in the power consumption of the processor at the time of the change from the operation executing state to the instruction processing stop state and at the time of the change from the instruction processing stop state to the operation executing state is becoming large.
[Patent Document 1] Japanese Laid-open Patent Publication No. 2001-142558
[Patent Document 2] Japanese Laid-open Patent Publication No. 2004-013280
[Patent Document 3] Japanese Laid-open Patent Publication No. 2009-123235

### SUMMARY

According to an aspect of the embodiment, a processing device includes: a clock generating circuit that outputs a clock; an instruction executing circuit that is capable of a state change between an instruction executing state where an instruction is executed and an instruction stop state where an instruction is stopped; a first circuit that inhibits the supply of the clock to a first internal circuit built in itself when a first clock inhibition signal is input; a second circuit that inhibits the supply of the clock to a second internal circuit built in itself when a second clock inhibition signal is input; and a control circuit. The control circuit outputs the second clock inhibition signal to the second circuit after outputting the first clock inhibition signal to the first circuit, when the instruction executing circuit changes from the instruction executing state to the instruction stop state.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processor according to an embodiment;

FIG. 2 is a diagram illustrating a configuration example of a core of the processor in this embodiment;

FIG. 3 is a diagram illustrating a configuration example of a power control circuit in this embodiment;

FIG. 4 is a diagram illustrating a configuration example of a clock gating circuit in this embodiment;

FIG. 5 is a diagram illustrating a configuration example of an instruction control unit in this embodiment; and

FIG. 6 is an explanatory chart of a change in power consumption at the time of state changes in this embodiment.

### DESCRIPTION OF EMBODIMENT

Hereinafter, a preferred embodiment will be explained based on the drawings.

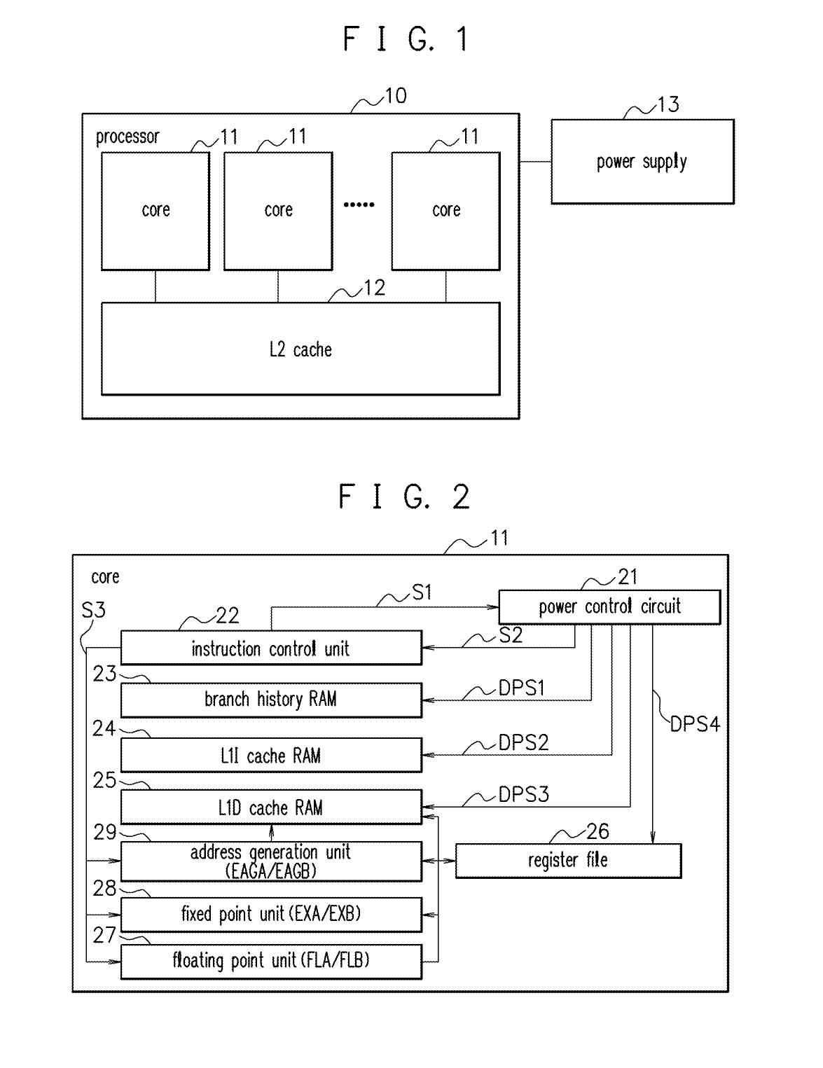

FIG. 1 is a diagram illustrating a configuration example of a processor as a processing device according to one embodiment. The processor 10 in this embodiment has a plurality of cores 11 and a secondary cache memory (L2 (Level-2) cache) 12. In the processor 10, the plural cores 11 share the secondary cache memory 12. Further, the processor 10 is supplied with power from a power supply 13. FIG. 1 illustrates an example where one power supply 13 is provided for one processor 10, but a plurality of the power supplies 13 may be provided for one processor 10 or one power supply 13 may be provided for a plurality of the processors 10.

FIG. 2 is a diagram illustrating a configuration example of the core 11 in this embodiment. The core 11 has a power control circuit 21, an instruction control unit 22, a branch history memory (branch history RAM) 23, a primary instruction cache memory (L1I (Level-1 Instruction) cache RAM) 24, and a primary data cache memory (L1D (Level-1 Data) cache RAM) 25. Further, the core 11 has a register file 26, a floating point operation unit (floating point unit) 27, a fixed point operation unit (fixed point unit) 28, and an address generation unit 29.

The power control circuit 21 receives a change signal S1 indicating a change to a suspend state or a sleep state from the instruction control unit 22. The power control circuit 21 outputs power reduction suppression signals DPS1 to DPS4 to the branch history memory 23, the primary instruction cache memory 24, the primary data cache memory 25, and the register file 26. Further, the power control circuit 21 receives a cancel signal S1 indicating the cancellation of the suspend state or the sleep state from the instruction control unit 22 and outputs a use prohibition signal S2 of the arithmetic units to the instruction control unit 22.

The instruction control unit 22 sequentially executes a sequence of instructions read from the primary instruction cache memory 24. When executing the suspend instruction or the sleep instruction, the instruction control unit 22 changes to the suspend state or the sleep state according to the instruction to stop the instruction processing and notifies this to the power control circuit 21 by the signal S1. Further, the instruction control unit 22 monitors the establishment of a cancellation condition of the suspend state or the sleep state (time, external interrupt, or the like). When the cancellation condition of the suspend state or the sleep state is established, the instruction control unit 22 cancels the suspend state or the sleep state to resume the instruction processing, and notifies this to the power control circuit 21 by the signal S1. Further, when receiving the use prohibition signal S2 of the arithmetic units from the power control circuit 21, the instruction control unit 22 performs instruction control so that only an arithmetic unit whose use is not prohibited orders arithmetic processing.

The branch history memory 23 is a RAM which retains a branch history. The branch history includes branch destination addresses of branch instructions executed in the past, a branch taken or not taken, and so on). The branch history memory 23 includes a clock gating circuit which inhibits the supply of a clock from a PLL (Phase Locked Loop) circuit (not shown) to its internal RAM storing the branch history, and when the branch history is not referred to or updated, the clock gating circuit inhibits the supply of the clock to the RAM to reduce power consumption. However, while the branch history memory 23 receiving the power reduction suppression signal DPS1 from the power control circuit 21, the supply of the clock to the RAM is not inhibited but is continued even when the branch history is not referred to or updated, whereby a reduction in power consumption is suppressed.

The primary instruction cache memory 24 is a RAM which stores instructions to be executed. The primary instruction cache memory 24 includes a clock gating circuit which inhibits the supply of the clock from the PLL circuit (not shown) to its internal RAM cell storing the instructions, and the clock gating circuit inhibits the supply of the clock to the RAM when there is no instruction read request from the instruction control unit 22 or when there is no instruction write request from the secondary cache memory 12, thereby reducing power consumption. However, while the primary instruction cache memory 24 is receiving the power reduction suppression signal DPS2 from the power control circuit 21, the supply of the clock to the RAM is not inhibited but is continued even when the primary instruction cache memory 24 is not referred to or updated, whereby a reduction in power consumption is suppressed.

The primary data cache memory 25 is a RAM which stores data used at the time of the instruction execution. The primary data cache memory 25 includes a clock gating circuit which inhibits the supply of the clock from the PLL (not shown) to its internal RAM cell storing the data, and when there is no data read request or write request from the instruction control unit 22 or no request (data read, data write, invalidation, and so on) from the secondary cache memory 12, the clock gating circuit inhibits the supply of the clock to the RAM, thereby reducing power consumption. However, while the primary data cache memory 25 is receiving the power reduction suppression signal DPS3 from the power control circuit 21, the supply of the clock to the RAM is not inhibited but is continued even when the primary data cache memory 25 is not referred to or updated, whereby a reduction in power consumption is suppressed.

The register file 26 is a group of registers which hold data used in various kinds of arithmetic processing. The register file 26 includes a clock gating circuit which inhibits the supply of the clock from the PLL circuit (not shown) to its internal flip-flops which hold the data, and when there is no read request or write request for the registers from the floating point operation unit 27, the fixed point operation unit 28, the address generation unit 29, or the primary data cache memory 25, the clock gating circuit inhibits the supply of the clock to the register file 26, thereby reducing power consumption. However, while the register file 26 is receiving the power reduction suppression signal DPS4 from the power control circuit 21, the supply of the clock to the register file 26 is not inhibited but is continued even when the register file 26 is not referred to or updated, whereby a reduction in power consumption is suppressed.

The floating point operation unit 27 performs a floating point operation, and includes two floating point arithmetic units FLA, FLB. In the arithmetic operation by the floating point operation unit 27, data used is read from the register file 26, and an operation result is written to the register file 26. The floating point arithmetic units FLA and FLB do not have the same function, but operations that can be processed by the floating point arithmetic unit FLB can all be processed also by the floating point arithmetic unit FLA. While the use prohibition signal S2 (fla only) of units except the floating point arithmetic unit FLA is output from the power control circuit 21, the instruction control unit 22 performs instruction control so that only the floating point arithmetic unit FLA orders the floating point processing. Therefore, while the use prohibition signal S2 (fla only) of units except FLA is output, the arithmetic processing is not executed in the floating point arithmetic unit FLB, resulting in a reduction in power consumption.

The fixed point operation unit 28 performs a fixed point operation and includes two fixed point arithmetic units EXA, EXB. In the arithmetic operation in the fixed point operation unit 28, data used is read from the register file 26 and an operation result is written to the register file 26. The fixed point arithmetic units EXA and EXB do not have the same function, but operations that can be processed by the fixed point arithmetic unit EXB can all be processed also by the fixed point arithmetic unit EXA. While the use prohibition signal S2 (exa only) of units except the fixed point arithmetic unit EXA is output from the power control circuit 21, the instruction control unit 22 performs instruction control so that only the fixed point arithmetic unit EXA orders the fixed point processing. Therefore, while the use prohibition signal S2 (exa only) of units except EXA is output, the arithmetic processing is not executed in the fixed point arithmetic unit EXB, resulting in a reduction in power consumption.

The address generation unit 29 performs address calculation of data being a load target or an store target regarding a load instruction or a store instruction for which memory access is performed, and includes two address generation units EAGA, EAGB. In the address calculation in the address generation unit 29, data used is read from the register file 26 and an address generated by the address generation unit 29 is notified to the primary data cache memory 25. At the time of the execution of the load instruction, the data read from the primary data cache memory 25 is written to the register file 26. And at the time of the execution of the store instruction, the data read from the register file 26 is written to the primary data cache memory 25. The address generation units EAGA 29A and EAGB 29B do not have the same function, but the load/store that can be processed by the address generation unit EAGB 29B can all be processed also by the address generation unit EAGA 29A. While the use prohibition signal S2 (eaga only) of units except the address generation unit EAGA is output from the power control unit 21, the instruction control unit 22 performs instruction control so that only the address generation unit EAGA 29A orders the address generation processing for load/store. Therefore, while the use prohibition signal S2 (eaga only) of units except EAGA 29A is output, the address generation processing is not executed in the address generation unit EAGB 29B, resulting in a reduction in power consumption.

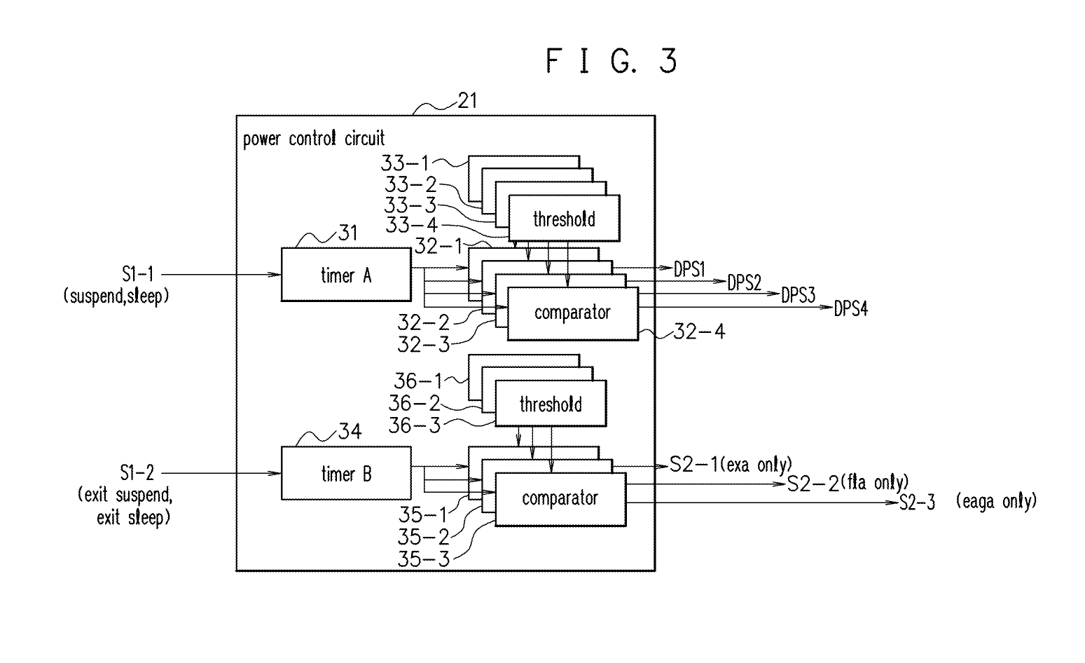

FIG. 3 is a diagram illustrating a configuration example of the power control circuit 21 in this embodiment. The power control circuit 21 has a timer circuit A (timer A) 31, a timer circuit B (timer B) 34, and comparison circuits (comparators) 32, 35. The timer circuit A31 measures the time after the change to the suspend state or the sleep state. The timer circuit B34 measures the time after the cancellation of the suspend state or the sleep state. The comparison circuits 32 compare value of the timer circuit A31 and thresholds 33. The comparison circuits 35 compare value of the timer circuit B34 and thresholds 36.

In the timer circuit A31, the value that it holds becomes 0 (zero) in states other than the suspend state or the sleep state, and in the suspend state or the sleep state, it counts up the value that it holds. The number of the comparison circuits 32 which compare the value of the timer circuit A31 and the thresholds 33 is two or more. In the example illustrated in FIG. 3, four comparison circuits 32-1 to 32-4 are provided, and when the value of the timer circuit A31 is smaller than the thresholds 33, they output the power reduction suppression signals DPS1 to DPS4 respectively.

In the timer circuit B34, the value that it holds becomes 0 (zero) in the suspend state or the sleep state, and in the states other than the suspend state or the sleep state, it counts up the value that it holds. The number of the comparison circuits 35 which compare the value of the timer circuit B34 and the thresholds 36 is two or more. In the example illustrated in FIG. 3, three comparison circuits 35-1 to 35-3 are provided, and they output the use prohibition signals S2-1 (exa only), S2-2 (fla only), and S2-3 (eaga only) of the arithmetic units when the value of the timer circuit B34 is smaller than the thresholds 36.

In order to prevent the values that the timers hold from exceeding the maximum value to return to 0 (zero) when a wrap-around occurs, the timer circuits A31, B34 stop counting up when the maximum value of the timers is reached, or stop counting up when the value of the timers is exceeded the maximum value of the plural thresholds. Here, the thresholds 33, 36 are formed by registers capable of setting an arbitrary value from 0 (zero) to the timer maximum value, and the setting of the value can be performed from hardware or firmware by using scan control by I2C (Inter-Integrated Circuit), JTAG (Joint Test Architecture Group), or the like.

The values of the thresholds 36 with which the value of the timer circuit B34 is compared are preferably set so that the use prohibition signals of the arithmetic units are cancelled in order from an arithmetic unit that is most likely to be used after the cancellation of the suspend state, in order to make performance deterioration after the cancellation of the suspend state small. After the cancellation of the suspend state, a sequence of instructions for timer interrupt or external interrupt processing is executed, and this processing includes mainly the load instruction or the store instruction and the fixed point operation instruction. On the other hand, this processing includes almost no floating point operation instruction. Therefore, by setting the thresholds so as to satisfy, for example, the relation of the threshold 36-3≦the threshold 36-1≦the threshold 36-2 so that the cancellation order of the use prohibition of the arithmetic units becomes the address generation unit EAGA→the fixed point arithmetic unit EXA→the floating point arithmetic unit FLA, it is possible to avoid the deterioration in the processing performance. For example, in a structure where the timer circuit B34 can measure 50 μs from the cancellation of the suspend state, by setting the threshold 36-3 for the output of the use prohibition signal S2-3 (eaga only) to 10 μs, setting the threshold 36-1 for the output of the use prohibition signal S2-1 (exa only) to 20 μs, and setting the threshold 36-2 for the output of the use prohibition signal S2-2 (fla only) to 30 μs, it is possible to reduce the power supply noise while avoiding the deterioration in the processing performance. Incidentally, the use prohibition signals of the arithmetic units may be cancelled in order of the fixed point arithmetic unit EXA→the address generation unit EAGA→the floating point arithmetic unit FLA. Further, the cancellation order of the use prohibition of the arithmetic units may be the fixed order as described above, but the order may be dynamically changed. For example, adoptable is a structure in which an arithmetic unit used immediately before the execution of the suspend instruction is stored, and after the cancellation of the suspend state, the use prohibition signals are cancelled in order from the stored arithmetic unit.

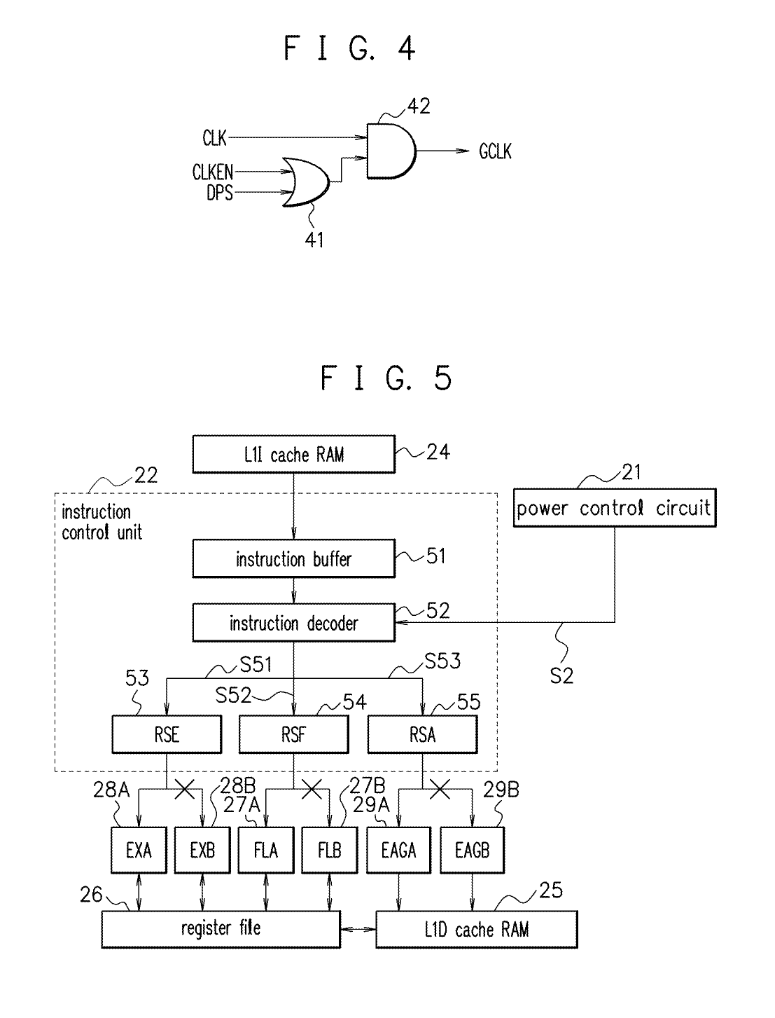

FIG. 4 is a diagram illustrating a configuration example of the clock gating circuit in this embodiment that the branch history memory 23, the primary instruction cache memory 24, the primary data cache memory 25, and the register file 26 each have. The clock gating circuit in this embodiment has a logical sum circuit (OR circuit) 41 and a logical product circuit (AND circuit) 42. The OR circuit 41 receives a clock enable signal CLKEN permitting the supply of the clock and the power reduction suppression signal DPS and outputs a result of the logical sum operation of these. The AND circuit 42 receives the output being the result of the logical sum operation of the OR circuit 41 and also receives a clock signal CLK from the PLL circuit via a clock tree (not shown) where the clock propagates, and when the result of the logical sum operation is 1, it outputs a gated clock signal GCLK as a result of the logical product operation. The gated clock signal GCLK is supplied to the RAM in the branch history memory 23, the RAM cell in the primary instruction cache memory 24 or the primary data cache memory 25, or the flip-flops in the register file. In the clock gating circuit illustrated in FIG. 4, when the power reduction suppression signal DPS is 1, the gated clock GCLK is not inhibited irrespective of the clock enable signal CLKEN, so that the reduction in power consumption is suppressed. Note that the clock enable signal CLKEN is controlled so as to have an enable state (for example, a value of 1) only when the RAMs or the register file are referred to or updated.

FIG. 5 is a diagram illustrating a configuration example of the instruction control unit 22 in this embodiment. The instruction control unit 22 has an instruction buffer 51, an instruction decoder 52, a reservation station for fixed point operation (RSE) 53, a reservation station for floating point operation (RSF) 54, and a reservation station for address generation (RSA) 55. The instruction buffer 51 retains one or more instructions read from the primary instruction cache memory 24 and supplies the instruction to the instruction decoder 52.

The instruction decoder 52 decodes the instruction supplied from the instruction buffer 51 and issues the instruction to the RSE 53, the RSF 54, and the RSA 55 according to the kind of the instruction. When decoding a fixed point operation instruction while receiving a use prohibition signal S2-1 (exa only) of units except the fixed point arithmetic unit EXA 28A from the power control circuit 21, the instruction decoder 52 issues the instruction to the RSE 53 together with a use prohibition instruction S51 of units except for the EXA 28A. Further, when decoding a floating point operation instruction while receiving a use prohibition signal S2-2 (fla only) of units except the floating point arithmetic unit FLA 27A from the power control circuit 21, the instruction decoder 52 issues the instruction to the RSF 54 together with a use prohibition instruction S52 of units except the FLA 27A. Further, when decoding the load instruction or the store instruction while receiving a use prohibition signal S2-3 (eaga only) of units except the address generation unit EAGA 29A from the power control circuit 21, the instruction decoder 52 issues the instruction to the RSA 55 together with a use prohibition instruction S53 of units except the EAGA 29A.

The RSE 53 receives the fixed point operation instruction from the instruction decoder 52 and after waiting for all data used for the arithmetic processing to be prepared, it supplies the instruction and the data to one of the fixed point arithmetic units EXA 28A, EXB 28B. When the instruction is appended with the use prohibition instruction S51 of units except the EXA 28A, the RSE 53 supplies the instruction and the data only to the fixed point arithmetic unit EXA 28A.

The RSF 54 receives the floating point operation instruction from the instruction decoder 52, and after waiting for all data used for the arithmetic processing to be prepared, it supplies the instruction and the data to one of the floating point arithmetic units FLA 27A, FLB 27B. When the instruction is appended with the use prohibition instruction S52 of units except FLA 27A, the RSF 54 supplies the instruction and the data only to the floating point arithmetic unit FLA 27A.

The RSA 55 receives the load instruction or the store instruction from the instruction decoder 52, and after waiting for all data used for load address calculation or store address calculation to be prepared, it supplies the instruction and the data to one of the address generation units EAGA 29A, EAGB 29B. When the instruction is appended with the use prohibition instruction S53 of units except the EAGA 29A, the RSA 55 supplies the instruction and the data only to the address generation unit EAGA 29A.

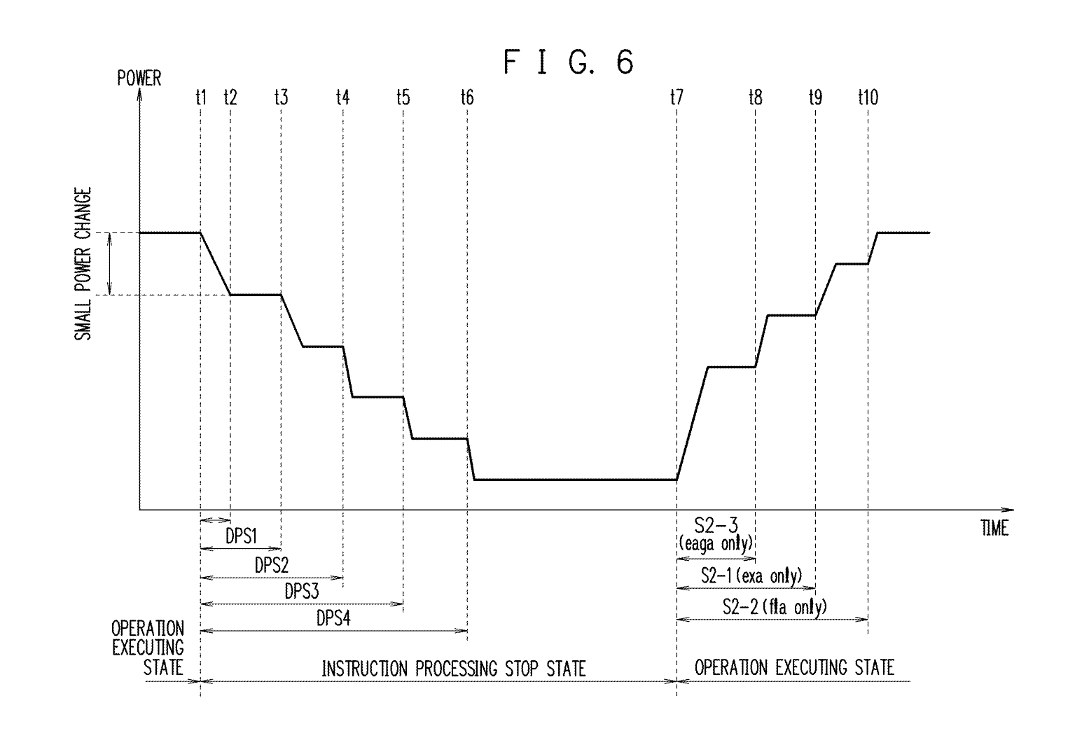

FIG. 6 illustrates a change in power consumption when the processor of this embodiment changes from the operation executing state to the instruction processing stop state and thereafter changes from the instruction processing stop state to the operation executing state. Note that FIG. 6 illustrates an example where the power reduction suppression signals are cancelled in order of the branch history memory 23→the primary instruction cache memory 24→the primary data cache memory 25→the register file 26 and the use prohibition signals are cancelled in order of the address generation unit 29→the fixed point arithmetic unit 28→the floating point arithmetic unit 27.

At a time t1, when the processor 10 changes from the operation executing state to the instruction processing stop state in response to the suspend instruction or the sleep instruction, the supply of the clock is first stopped in circuit blocks where power can be reduced except the branch history memory 23, the primary instruction cache memory 24, the primary data cache memory 25, and the register file 26, so that power consumption reduces (times t1 to t2). Next, at a time t3, when the power reduction suppression signal DPS1 is cancelled, the supply of the clock to the RAM in the branch history memory 23 is inhibited. Next, at a time t4, when the power reduction suppression signal DPS2 is cancelled, the supply of the clock to the RAM cell in the primary instruction cache memory 24 is inhibited. Next, at a time t5, when the power reduction suppression signal DPS3 is cancelled, the supply of the clock to the RAM cell in the primary data cache memory 25 is inhibited. Next, at a time t6, when the power reduction suppression signal DPS4 is cancelled, the supply of the clock in the register file 26 is inhibited. In this manner, in the case of the change from the operation executing state to the instruction processing stop state, the supply of the clock is stopped in order of the branch history memory 23→the primary instruction cache memory 24→the primary data cache memory 25→the register file 26, which makes it possible to prevent a sharp and great change in power consumption, enabling the prevention of the occurrence of the power supply noise.

At a time t7, when the processor 10 changes from the instruction processing stop state to the operation executing state, the use of the arithmetic unit except the address generation unit EAGA 29A in the address generation unit 29, the arithmetic unit except the fixed point arithmetic unit EXA 28A in the fixed point operation unit 28, and the arithmetic unit except the floating point arithmetic unit FLA 27A in the floating point operation unit 27 is inhibited. Next, at a time t8, when the use prohibition signal S2-3 of units except the EAGA 29A is cancelled, the address generation units of the address generation unit 29 all become usable. Next, at a time t9, when the use prohibition signal S2-1 of units except the EXA 28A is cancelled, all the arithmetic units of the fixed point operation unit 28 become usable. Next, at a time t10, when the use prohibition signal S2-2 of units except FLA 27A is cancelled, all the arithmetic units of the floating point operation unit 27 become usable. In this manner, in the case of the change from the instruction processing stop state to the operation executing state, the arithmetic units are made usable in sequence, whereby a sharp and great change in power consumption is prevented, enabling the prevention of the occurrence of the power supply noise.

As described above, according to this embodiment, in the case of the change from the operation executing state to the instruction processing stop state, the power reduction suppression signals DPS1 to DPS4 are output from the power control circuit 21, and while they are 1, the clock gating to the register and the RAM is inhibited and the clock is supplied to the register and the RAM, which makes it possible to decrease a deterioration width of power consumption. Further, based on the comparison between the value of the timer circuit A31 and the thresholds 33, the number of the destinations of the power reduction suppression signals DPS1 to DPS4 is reduced in stages, which makes it possible to reduce power in stages without being accompanied by a great power change. Since the power consumption becomes the smallest when none of the power reduction suppression signals DPS1 to DPS4 is output, the smallest power consumption can be made equivalent to conventional one.

Further, in the case of the change from the instruction processing stop state to the operation executing state, the use prohibition signals S2 for part of the arithmetic units are output from the power control circuit 21, so that part of the arithmetic units large in power consumption is not used. Therefore, the power consumption of the processor does not become largest, which makes it possible to make an increase width of the power consumption. Based on the comparison between the value of the timer circuit B34 and the thresholds 36, the use prohibition signals are cancelled in stages in order from the arithmetic unit most likely to be used after the instruction processing stop state, which makes it possible to increase power in stages without being accompanied by a great power change while avoiding performance deterioration. When none of the use prohibition signals S2 of the arithmetic units is output, all the arithmetic units become usable, so that the maximum performance can be made equivalent to conventional one.

The processing device disclosed herein is capable of preventing the power supply noise from occurring at the time of the change from the instruction executing state to the instruction stop state.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processing device comprising:
a clock generating circuit that outputs a clock;
an instruction executing circuit that is capable of a state change between an instruction executing state where an instruction is executed and an instruction stop state where an instruction is stopped;
a first circuit that inhibits the supply of the clock to a first internal circuit built in the first circuit when a first clock inhibition signal is input;
a second circuit that inhibits the supply of the clock to a second internal circuit built in the second circuit when a second clock inhibition signal is input; and
a control circuit that outputs the second clock inhibition signal to the second circuit after outputting the first clock inhibition signal to the first circuit, when the instruction executing circuit changes from the instruction executing state to the instruction stop state.

2. The processing device according to claim 1, wherein:
the first circuit further continues the supply of the clock to the first internal circuit irrespective of the first clock inhibition signal, when a first clock continuation signal is input;
the second circuit further continues the supply of the clock to the second internal circuit irrespective of the second clock inhibition signal, when a second clock continuation signal is input; and
the control circuit further outputs the first clock continuation signal to the first circuit after outputting the second clock continuation signal to the second circuit, when the instruction executing circuit changes from the instruction stop state to the instruction executing state.

3. A method for controlling a processing device having a clock generating circuit that outputs a clock and an instruction executing circuit that is capable of a state change between an instruction executing state where an instruction is executed and an instruction stop state where the instruction is stopped, the method comprising:
by a control circuit included in the processing device, outputting a first clock inhibition signal to a first circuit to inhibit the supply of the clock to a first internal circuit built in the first circuit, when the instruction executing circuit changes from the instruction executing state to the instruction stop state; and
by the control circuit, outputting a second clock inhibition signal to a second circuit after outputting the first clock inhibition signal to the first circuit, to inhibit the supply of the clock to a second internal circuit built in the second circuit.

4. The method for controlling the processing device according to claim 3, wherein:
the first circuit further continues the supply of the clock to the first internal circuit irrespective of the first clock inhibition signal, when a first clock continuation signal is input;
the second circuit further continues the supply of the clock to the second internal circuit irrespective of the second clock inhibition signal, when a second clock continuation signal is input; and
the control circuit further outputs the first clock continuation signal to the first circuit after outputting the second clock continuation signal to the second circuit, when the instruction executing circuit changes from the instruction stop state to the instruction executing state.
